(19) United States
(12) Patent Application Publication
(10) Pub. No.: US 2005/0264214 A1
(43) Pub. Date: Dec. 1, 2005

(54) Discharge light source and method of fabricating the same

(75) Inventor: Tsuyoshi Haga, Ako-gun (JP)

Correspondence Address: MCDERMOTT WILL & EMERY LLP, 600 13TH STREET, N.W., WASHINGTON, DC, 20005-3096, US

(73) Assignee: SUMITOMO ELECTRIC INDUSTRIES, LTD.

(21) Appl. No.: 11/114,159

(22) Filed: Apr. 26, 2005

(30) Foreign Application Priority Data
May 26, 2004 (JP) 2004-156511(P)

(51) Int. Cl. H01J 17/16

(52) U.S. Cl. 313/634

(57) ABSTRACT

A method of fabricating a discharge light source that emits light by discharge between a pair of electrodes arranged within a sealed space includes the steps of: forming a concave portion by etching the main surface of a Si substrate; forming an electrically conductive film on the main surface of a membrane film; forming the pair of electrodes by etching the electrically conductive film; and with the main surface having the pair of electrodes formed thereon facing downward, arranging the membrane film on the main surface of the Si substrate so that the pair of electrode is positioned over the concave portion to form the sealed space. Thus, a discharge light source that can be made smaller and a method of fabricating the same can be obtained.

### BACKGROUND OF THE INVENTION

1. Field of the Invention

The present invention relates to a discharge light source and a method of fabricating the same, and more particularly, to a discharge light source that can be made smaller and a method of fabricating the same.

2. Description of the Background Art

Commonly used light sources include HID (High Intensity Discharge) lamps, fluorescent tubes, filament lamps, white LEDs (Light Emitting Diode) and the like, for example. Of them, HID lamps have the following advantages compared to other light sources. Since HID lamps have a larger luminous flux per lamp compared to fluorescent tubes and the like, they are suitable for a light source for a large-scale space. Further, HID lamps are excellent in luminous efficiency compared to filament lamps and lead to energy conservation for a facility that introduces HID lamps. In addition, HID lamps have a larger light divergence compared to white LEDs and are suitable to illuminate a large place. Further, HID lamps have a longer lifetime compared to other light sources, reducing running costs and maintenance costs.

A conventional HID lamp includes an elliptical arc tube (an arc bulb) formed of quartz glass and a pair of electrodes arranged within the arc tube to oppose to each other. Within the arc tube, an inert gas for starting discharge and a predetermined amount of mercury and a halogenated metal (an additive) are enclosed. A HID lamp like this is disclosed in Japanese Patent Laying-Open No. 5-89830, for example.

Conventionally, various efforts have been made to make a HID lamp smaller. However, since an arc tube formed of glass is shaped by machining, there has been a limit in making an arc tube smaller. Further, each of a pair of electrodes is arranged at a predetermined position within an arc tube using a machine, it has been difficult to arrange each of the pair of electrodes accurately. Therefore, there has been a limit in reducing a distance between the pair of electrodes. For these reasons, there has been a limit in making a HID lamp smaller.

### SUMMARY OF THE INVENTION

An object of the present invention is to provide a discharge light source that can be made smaller and a method of fabricating the same.

A method of fabricating a discharge light source that emits light by discharge between a pair of electrodes arranged within a sealed space according to the present invention includes the steps of: forming a concave portion by etching a main surface of a first substrate; forming an electrically conductive film on a main surface of a light-penetratable film; forming the pair of electrodes by etching the electrically conductive film; and arranging the light-penetratable film on the main surface of the first substrate with the main surface of the light-penetratable film facing downward so that the pair of electrodes is positioned over the concave portion to form the sealed space.

According to the method of fabricating a discharge light source of the present invention, the concave portion forming the sealed space is formed by etching, and the pair of electrodes is formed by etching. Thus, the sealed space and the pair of electrode can be formed by etching without machining so that the sealed space and the pair of electrodes can be made smaller. As a result, the discharge light source can be made smaller.

Preferably, the method further includes the steps of forming a light-penetratable film on a main surface of a second substrate, and forming a cavity on the second substrate.

Thus, a thin light-penetratable film can be formed uniformly and stably. Further, light caused by discharge can be emitted through a cavity so that the second substrate is not an obstacle for light emission.

In the method, the step of arranging is preferably performed by anodic bonding. Thus, both the first substrate and the second substrate are bonded in a solid phase so that bonding with high accuracy can be provided.

Preferably, the method further includes the step of forming a light-penetratable etching stopper film on the main surface of the light-penetratable film. The electrically conductive film is formed on the main surface of the light-penetratable film, with the etching stopper film interposed therebetween.

Thus, when etching the electrically conductive film, undesired etching of the light-penetratable film can be prevented. Since the etching stopper film is light-penetratable, it is not an obstacle for light emission.

In the method, it is preferable that a plurality of concave portions are formed when the aforementioned concave portion is formed and a plurality of pairs of electrode are formed when the aforementioned pair of electrodes is formed. The method further includes the step of dividing the first substrate to separate the plurality of concave portions from each other after the step of arranging.

Thus, a large number of discharge light sources can be fabricated on one substrate to improve production efficiency of a discharge light source.

In the method, the step of arranging preferably includes the step of applying an additive into the concave portion. The light-penetratable film is arranged on the first substrate in an atmosphere of an inert gas.

In the method, the step of arranging preferably includes the steps of applying an additive and a liquid inert gas into the concave portion, and after arranging the light-penetratable film on the first substrate, raising temperature to room temperature.

Thus, the inert gas and the additive can easily fill the inside of the sealed space.

A discharge light source of the present invention is a discharge light source that emits light by discharge between a pair of electrodes arranged within a sealed space, including a first substrate formed of Si (silicon) with a concave portion formed thereon, a light-penetratable film formed on a main surface of the first substrate to seal the concave portion, and the pair of electrodes arranged within the sealed space formed by the concave portion and the light-penetratable film.

For the discharge light source of the present invention, the concave portion forming the sealed space can be formed by etching without machining so that the sealed space can be made smaller. As a result, the discharge light source can be made smaller.

In the discharge light source of the present invention, the pair of electrode is preferably formed of W (tungsten) or Mo (molybdenum).

Thus, the pair of electrodes can be formed by etching without machining. Further, W and Mo have excellent durability to withstand discharge.

In the discharge light source of the present invention, the light-penetratable film is preferably formed of at least one material selected from the group consisting of SiN (silicon nitride), SiC (silicon carbide) and diamond.

Thus, sufficient mechanical strength is ensured even when the light-penetratable film is made thinner. As a result, the discharge light source can be further made smaller.

It is to be noted that “an additive” in the present invention means a metal or a halogenated metal that emits light due to collision of electrons.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a plan view showing a structure of a discharge light source of one embodiment of the present invention.

FIG. 2 is a sectional view along the line II-II of FIG. 1.

FIG. 3 is a sectional view along the line III-III of FIG. 1.

FIGS. 4-14 are sectional views sequentially showing the steps of a method of fabricating a discharge light source of one embodiment of the present invention.

FIG. 15 is an example of a circuit diagram using a discharge light source of one embodiment of the present invention.

FIG. 16 is another example of the circuit diagram using a discharge light source of one embodiment of the present invention.

### DESCRIPTION OF THE PREFERRED EMBODIMENTS

One embodiment of the present invention now will be described referring to the drawings.

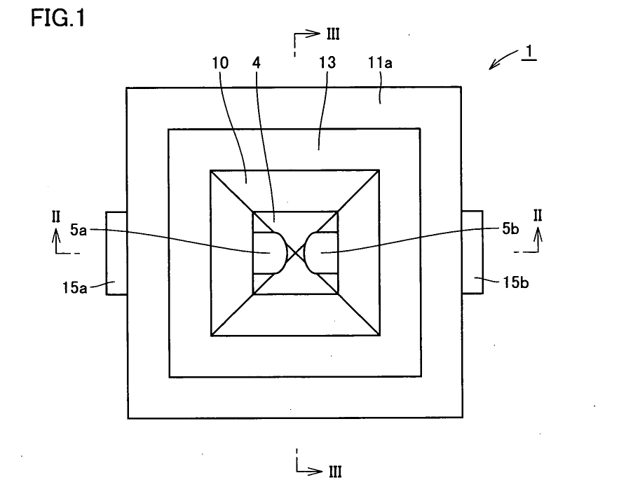

As shown in FIGS. 1-3, a discharge light source 1 of the present embodiment has a shape of nearly a rectangular parallelepiped and includes a Si substrate 3 as a first substrate, a pair of electrodes 5a, 5b, an etching stopper film 7, an adhesive layer 8, membrane films 11a, 11b as a light-penetratable film, a Si substrate 9 as a second substrate, a hard glass 13, and electrode terminals 15a, 15b.

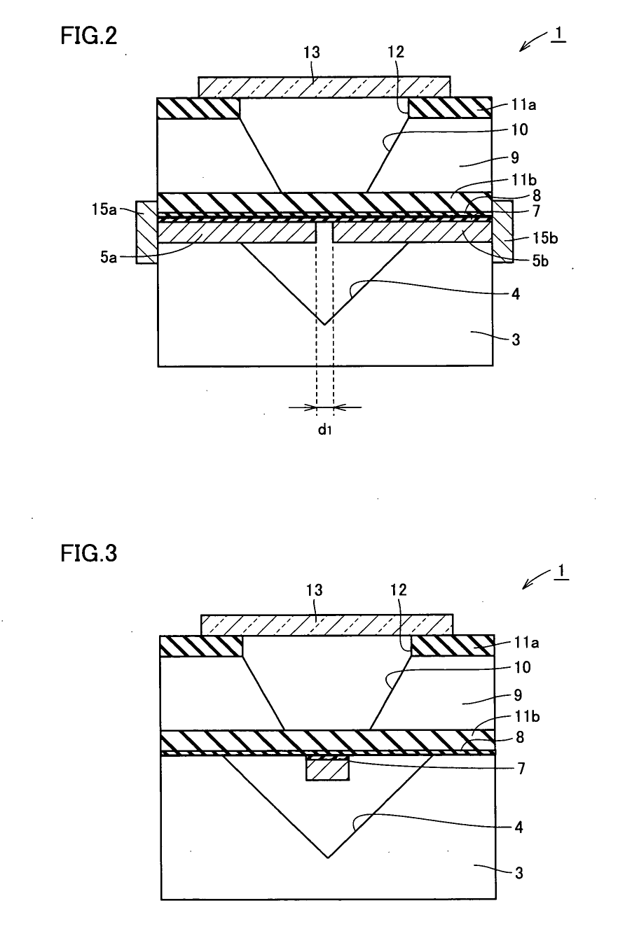

There is formed a concave portion 4 on Si substrate 3. On Si substrate 3 is formed pair of electrode 5a, 5b and pair of electrode 5a, 5b is arranged to oppose to each other over concave portion 4. Each of pair of electrodes 5a, 5b has a rod shape when viewed two-dimensionally and extends in the lateral direction in FIG. 1. An end portion of each of electrodes 5a, 5b has a semicircle shape when viewed two-dimensionally, for example. For example, the width of each of electrodes 5a, 5b (length in the longitudinal direction in FIG. 1) is 15 μm, and the thickness (length in the longitudinal direction in FIG. 2) is 2 μm. The distance between electrodes 5a, 5b is 40 μm, for example.

Etching stopper film 7 is formed on electrodes 5a, 5b. Etching stopper film 7 has a rod shape of approximately the same width as each of electrodes 5a, 5b when viewed two-dimensionally and extends in the lateral direction in FIG. 1. Electrodes 5a, 5b and etching stopper film 7 are arranged within the concave portion (not shown) formed on a main surface of Si substrate 3.

Membrane film 11b is formed on the main surface of Si substrate 3 via adhesive layer 8 to seal concave portion 4. Thus, concave portion 4 and membrane film 11b form a sealed space of discharge light source 1. Within the sealed space, a gas for starting discharge such as Ar (argon) and Xe (xenon) and a metal to emit light formed of halogenated Hg or halogenated Na for example are enclosed. Further, electrodes 5a, 5b are arranged within the sealed space.

Si substrate 9 is formed on membrane film 11b and membrane film 11a is formed on Si substrate 9. Membrane film 11a has an opening 12 and a cavity 10 communicated to opening 12 is formed on Si substrate 9. For example, cavity 10 has a shape of a quadrangular pyramid without an apex and membrane film 11b is exposed at the bottom of cavity 10. Si substrate 9 has a thickness (length in a longitudinal direction in FIG. 2) of 1 mm, for example. Cavity 10 has a shape of a square with a side of 3 mm when viewed two-dimensionally, for example.

Hard glass 13 is arranged on membrane film 11a to cover opening 12 and cavity 10. Hard glass 13 serves to protect membrane film 11b and blodck ultraviolet rays. It is to be noted that each of electrode terminals 15a, 15b is formed on a side portion of discharge light source 1 to be electrically connected to each of electrodes 5a, 5b.

Discharge light source 1 is a light source that emits light by discharge between pair of electrodes 5a, 5b arranged within the sealed space. More specifically, when high voltage is applied to each of electrode terminals 15a, 15b, electrons are emitted from one of electrodes 5a, 5b and are attracted and moved to the other of electrodes 5a, 5b. The electrons collide with atoms of an additive during moving and the atoms of the additive emit light. The light passes through etching stopper film 7, adhesive layer 8 and membrane film 11b, goes through cavity 10 and opening 12, and then is released to the outside through hard glass 13. Part of the light is reflected off an inner wall surface of concave portion 4 and released to the outside.

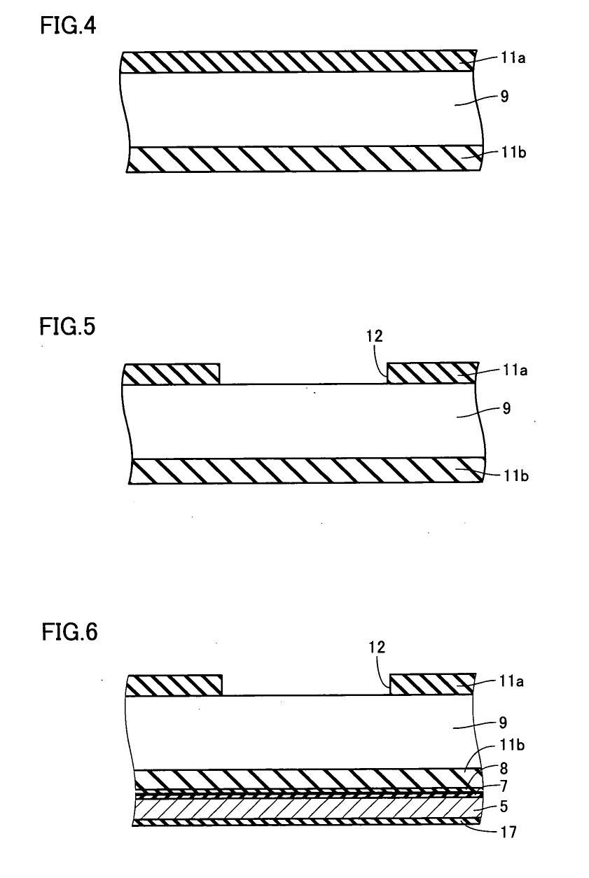

Next, a method of fabricating discharge light source 1 of the present embodiment will be described referring to FIGS. 4-14.

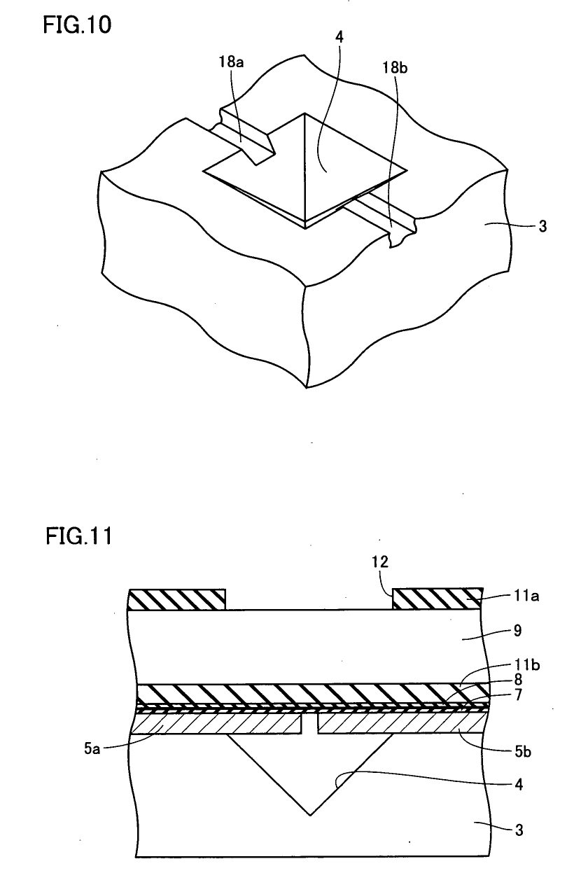

It is to be noted that FIG. 10 is a perspective view and all other figures except FIG. 10 are sectional views. In the present embodiment, a method of fabricating one discharge light source is shown, however, a plurality of discharge light sources are fabricated on Si substrate 3 with the same procedure as shown in FIGS. 4-13. In FIG. 13, an adjacent structure is also shown.

Referring to FIG. 4, at first, membrane films 11a, 11b formed of SiN, SiC or diamond, for example, are formed respectively on two main surfaces of Si substrate 9. For example, membrane films 11a, 11b are formed by the CVD method and have a thickness of 2 μm.

Referring to FIG. 5, opening 12 is formed on one membrane film 11a by commonly used photolithography technique and etching technique. For example, opening 12 has a square shape with a side of 3 mm when viewed two-dimensionally. It is to be noted that a plurality of openings 12 are formed in an adjacent region (not shown) at the same time when opening 12 is formed.

Referring to FIG. 6, adhesive layer 8 formed of SiO₂, for example, is formed to a thickness of 0.2 μm on a main surface of the other membrane film 11b. Then, etching stopper film 7 formed of Al₂O₃, for example, is formed to a thickness of 0.2 μm on adhesive layer 8. For etching stopper film 7, Cr (chromium) may be used instead of Al₂O₃. Since adhesive layer 8 and etching stopper film 7 are thin, they have a characteristic to let light pass through.

Then, an electrically conductive film 5 formed of W or Mo, for example, and an Al (aluminum) film 17 are formed as a laminate on etching stopper film 7. More specifically, electrically conductive film 5 is formed on the main surface of membrane film 11b with adhesive layer 8 and etching stopper film 7 interposed therebetween. For example, electrically conductive film 5 is formed by sputtering and has a thickness of 2 μm. For example, Al film 17 is formed by sputtering and has a thickness of 0.2 μm.

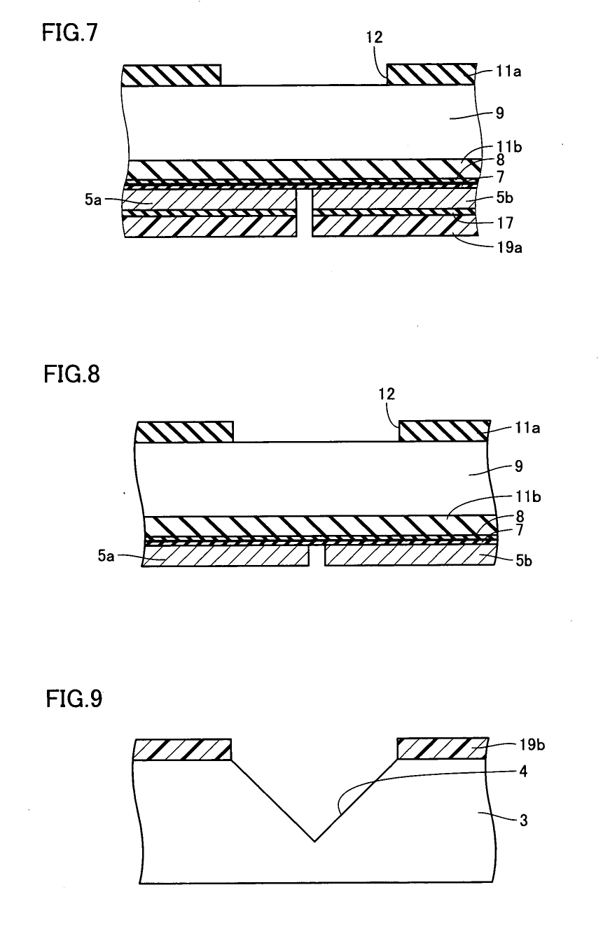

Referring to FIG. 7, a resist 19a is patterned on Al film 17 and, using resist 19a as a mask, Al film 17 is patterned to have the shape of electrodes 5a, 5b when viewed two-dimensionally. Then, using Al film 17 as a mask, electrically conductive film 5 is dry etched to form pair of electrodes 5a, 5b. When electrically conductive film 5 is dry etched, adhesive layer 8 and Si substrate 9 are not unnecessarily etched due to the presence of etching stopper film 7. It is to be noted that a plurality of electrodes 5a, 5b are formed in an adjacent region (not shown) at the same time when electrodes 5a, 5b are formed.

Referring to FIG. 8, Al film 17 and resist 19a are removed by wet etching or dry etching, for example. Thus, pair of electrodes 5a, 5b is exposed below Si substrate 9 in FIG. 7. Then, though not shown, etching stopper film 7 except for the portion where electrodes 5a, 5b are exposed is removed by wet etching, for example. Thus, electrodes 5a, 5b and adhesive layer 8 are exposed below Si substrate 9 in FIG. 7.

Referring to FIG. 9, aside from the structure shown in FIG. 8, Si substrate 3 is prepared. A resist 19b is patterned on the main surface of Si substrate 3. Then, using resist 19b as a mask, concave portion 4 is formed by etching the main surface of Si substrate 3. Concave portion 4 has a shape of a quadrangular pyramid and a depth of 1 mm, for example. Then, resist 19b is removed. It is to be noted that a plurality of concave portions 4 are formed in an adjacent region (not shown) at the same time when concave portion 4 is formed.

Referring to FIG. 10, a resist (not shown) is patterned on Si substrate 3 and, using resist 19a as a mask, Si substrate 3 is etched to form grooves 18a, 18b to arrange electrodes 5a, 5b. Then, the resist is removed.

Referring to FIG. 11, with the main surface having electrodes 5a, 5b formed thereon facing downward, membrane film 11b is arranged on the main surface of Si substrate 3 so that pair of electrodes 5a, 5b is positioned over concave portion 4. Thus, concave portion 4 and membrane film 11b form a sealed space. Then, adhesive layer 8 exposed below Si substrate 9 and Si substrate 3 are anodic-bonded. At this time, electrodes 5a, 5b are arranged within respective grooves 18a, 18b so that there is no gap between adhesive layer 8 and Si substrate 3.

When Si substrate 9 is arranged on the main surface of Si substrate 3, an inert gas (a gas for starting discharge) such as Ar and Xe, for example, an additive and mercury are enclosed within the sealed space formed by concave portion 4 and membrane film 11b. As the additive, for example, a metal such as Na (sodium), Li (lithium), Ti (thallium), In (indium), Ga (gallium), K (potassium), Sc (scandium), Dy (Dysprosium), Nd (neodymium), Tm (thulium), Ho (holmium), Th (thorium), Fe (iron) and Sn (tin), or a halogenated metal of these metals are used. Mercury serves as a buffer gas to obtain a desired voltage. Halogenated Cs (cesium) or halogenated Al (aluminum) may be further enclosed to increase a vapor pressure of the above metals.

The gas for starting discharge, the additive and mercury are enclosed by applying the additive and mercury into concave portion 4 by sputtering or casting for example and arranging Si substrate 9 on the main surface of Si substrate 3 in an atmosphere of an inert gas of a partial pressure of 0.5-3 MPa.

The enclosure of the gas for starting discharge, the additive and mercury may be performed by dripping 0.3-3 mm³ of the additive, mercury and a liquid inert gas into concave portion 4 within a chamber cooled down to −170° C. or lower with liquid nitride for example and raising temperature to room temperature after arranging Si substrate 9 on the main surface of Si substrate 3.

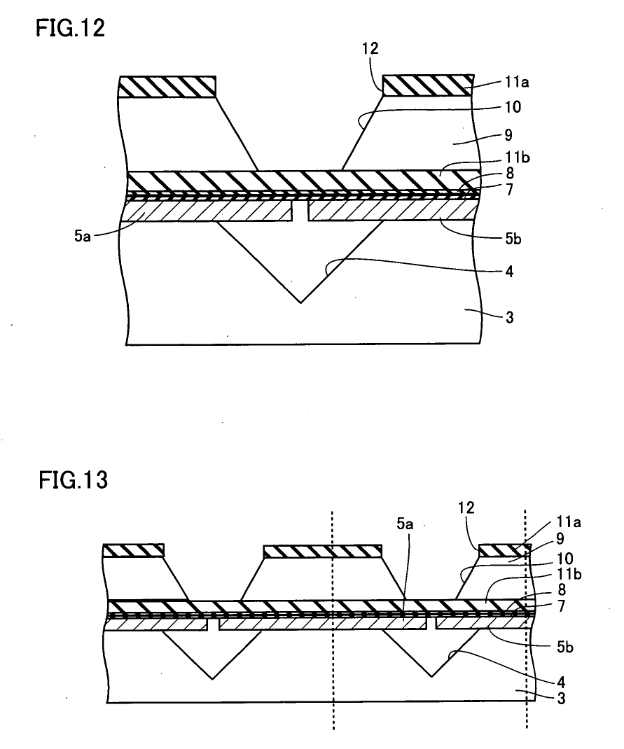

Referring to FIG. 12, cavity 10 is formed on Si substrate 9 by wet etching Si substrate 9 using KOH (potassium hydroxide) solution, for example. It is to be noted that a plurality of cavities 10 are formed in an adjacent region (not shown) when cavity 10 is formed. Further, the step of forming cavity 10 on Si substrate 9 may be performed at any stage and may be performed immediately after the step shown in FIG. 5 or the step shown in FIG. 6, for example.

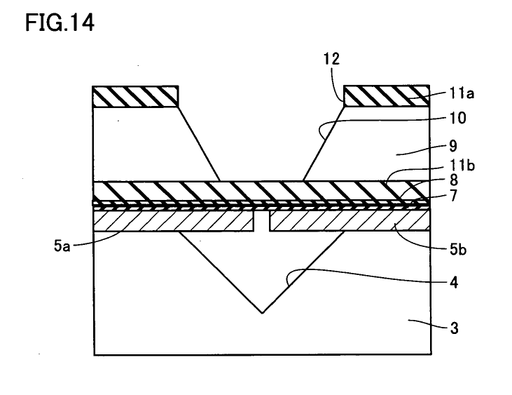

Referring to FIG. 13, Si substrate 3 and Si substrate 9 are divided along a dotted line in FIG. 13 so that the plurality of concave portions 4, the plurality of pairs of electrodes 5a, 5ba and the plurality of cavitys 10 are separated from each other. Thus, a structure shown in FIG. 14 can be obtained.

Referring to FIG. 2, each of electrode terminals 15a, 15b is formed on a side portion of discharge light source 1 to be electrically connected to the corresponding one of electrodes 5a, 5b. Each of electrode terminal 15a, 15b is formed by applying silver paste, for example. Thus, discharge light source 1 of the present embodiment can be obtained.

Next, a circuit diagram using a discharge light source of the present embodiment will be described.

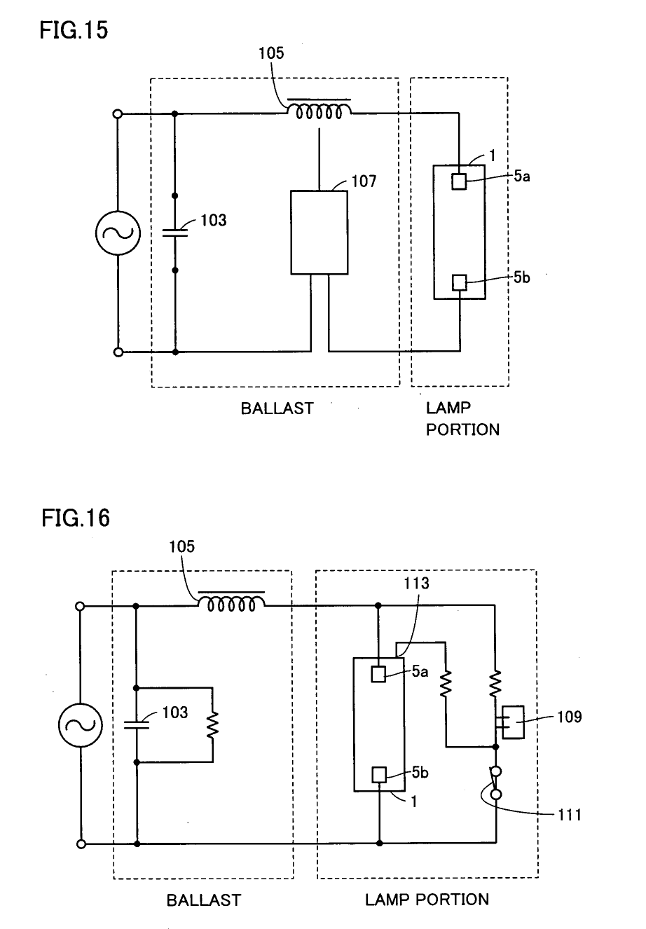

In a circuit diagram shown in FIG. 15, discharge light source 1 is electrically connected to a ballast having an ignitor 107 as a starter, a capacitor 103 for power-factor improvement and a coil 105. In a circuit like this, pulsed high voltage is applied between electrodes 5a, 5b of discharge light source 1 by ignitor 107, causing dielectric breakdown between electrodes 5a, 5b and starting discharge.

In a circuit diagram shown in FIG. 16, a lamp portion having a glow starter 109 as a starter, bimetal 111 and discharge light source 1 is electrically connected to a ballast mainly having capacitor 103 for power-factor improvement and coil 15 connected in series to capacitor 103. An auxiliary electrode 113 is formed in discharge light source 1. In a circuit like this, high voltage applied by glow starter 109 causes glow discharge between electrodes 5a, 5b and auxiliary electrode 113, and immediately a transition occurs from the glow discharge to arc discharge between electrodes 5a, 5b. It is to be noted that a distance d between electrodes 5a, 5b of the present invention is 40 μm and short so that discharge can be obtained by applying voltage of 10-50V.

A method of fabricating discharge light source 1 of the present embodiment that emits light by discharge between pair of electrode 5a, 5b arranged within a sealed space includes the steps of: forming concave portion 4 by etching a main surface of Si substrate 3; forming electrically conductive film 5 on a main surface of membrane film 11b; forming pair of electrode 5a, 5b by etching electrically conductive film 5; and with the main surface having pair of electrodes 5a, 5b formed thereon facing downward, arranging membrane film 11b on the main surface of Si substrate 3 so that pair of electrodes 5a, 5b is positioned over concave portion 4 to form a sealed space (the step of arranging).

According to the method of fabricating discharge light source 1 of the present embodiment, concave portion 4 forming the sealed space is formed by etching and pair of electrode 5a, 5b is formed by etching. Thus, the sealed space and pair of electrode 5a, 5b can be formed by etching without machining so that the sealed space and pair of electrodes 5a, 5b can be made smaller. As a result, the discharge light source can be made smaller. It is to be noted that discharge light source 1 of the present embodiment can be made smaller by at least one order of magnitude compared to a conventional HID lamp and can provide a submillimeter-sized light source. Discharge light source 1 consumes less energy by at least one order of magnitude compared to a filament lamp, since it does not use a filament. It has a further advantage of a longer lifetime for a small light source.

Preferably, the method further includes the steps of forming membrane film 11b on the main surface of Si substrate 9, and forming cavity 10 on Si substrate 9.

Thus, thin membrane film 11b can be formed uniformly and stably. Since light caused by discharge is emitted through cavity 10, Si substrate 9 is not an obstacle for light emission.

In the method, the step of arranging is preferably performed by anodic bonding. Thus, both Si substrate 3 and membrane film 11b are bonded in solid phase so that accurate bonding can be obtained.

Preferably, the method further includes the step of forming light-penetratable etching stopper film 7 on the main surface of membrane 11b. Electrically conductive film 5 is formed on the main surface of membrane film 11b with etching stopper film 7 interposed therebetween.

Thus, when etching electrically conductive film 5, undesired etching of membrane 11b can be prevented. Further, etching stopper film 7 is light-penetratable so that it is not an obstacle for light emission.

In the method, it is preferable that a plurality of concave portions 4 are formed when concave portion 4 is formed and a plurality of pairs of electrodes 5a, 5b are formed when pair of electrodes 5a, 5b is formed. After the step of arranging, the method further includes the step of dividing Si substrate 3 to separate the plurality of concave portions 4 from each other.

Thus, a large number of discharge light sources can be fabricated on one substrate so that production efficiency is improved.

In the method, the step of arranging preferably includes the step of applying an additive into concave portion 4. Membrane film 11b is arranged on Si substrate 3 in an atmosphere of an inert gas.

In the method, the step of arranging preferably includes the steps of applying an additive and a liquid inert gas into concave portion 4, and raising temperature to room temperature after membrane film 11b is arranged on Si substrate 3.

Thus, the inert gas and the additive can easily fill the inside of the sealed space.

Discharge light source 1 of the present embodiment is a discharge light source that emits light by discharge between pair of electrodes 5a, 5b arranged within a sealed space and includes Si substrate 3 with concave portion 4 formed thereon, membrane film 11b formed on a main surface of Si substrate 3 to seal concave portion 4, and pair of electrodes 5a, 5b arranged within the sealed space formed by concave portion 4 and membrane film 11b.

According to the discharge light source of the present embodiment, concave portion 4 forming the sealed space can be formed by etching without machining so that the sealed space can be made smaller. As a result, the discharge light source can be made smaller.

In the discharge light source of the present embodiment, pair of electrodes 5a, 5b is formed of W or Mo.

Thus, the pair of electrodes can be formed by etching without machining. Further, W and Mo have excellent durability to withstand discharge.

In discharge light source 1 of the present embodiment, membrane film 11b is formed of at least one material selected from the group consisting of SiN, SiC and diamond.

Thus, sufficient mechanical strength is ensured even when membrane film 11b is made thinner. As a result, the discharge light source can be further made smaller.

It is to be noted that the present embodiment shows a case in which membrane film 11b and Si substrate 3 are anodic-bonded by forming grooves 18a, 18b on Si substrate 3. However, instead of forming grooves 18a, 18b on Si substrate 3, a glass film may be formed to have the same thickness as electrodes 5a, 5b on etching stopper film 7 and then the glass film and Si substrate may be anodic-bonded. Instead of anodic bonding between membrane film 11b and Si substrate 3, membrane film 11b may be removed to expose Si substrate 9 and Si substrate 9 and Si substrate 3 may be anodic-bonded. Further, Si substrate 3 and membrane film 11b may be bonded by a bonding technique such as an adhesive other than anodic bonding. In the present invention, it is at least sufficient that a light-penetratable film is arranged on the main surface of the first substrate.

The discharge light source of the present invention is a divergent light source and is suitable for a very small room lamp, a light for a CCD (Charge-Coupled Device) camera of a mobile phone or a room lamp for an automobile.

It should be understood that the embodiment disclosed herein are illustrative and non-restrictive in every respect. The scope of the present invention is defined by the terms of the claims, rather than the description above, and is intended to include any modifications within the scope and meaning equivalent to the terms of the claims.

1. A method of fabricating a discharge light source that emits light by discharge between a pair of electrodes arranged within a sealed space, comprising the steps of:
forming a concave portion by etching a main surface of a first substrate;
forming an electrically conductive film on a main surface of a light-penetratable film;
forming said pair of electrodes by etching said electrically conductive film; and
arranging said light-penetratable film on said main surface of said first substrate with said main surface of said light-penetratable film facing downward so that said pair of electrodes is positioned over said concave portion to form said sealed space.

2. The method of claim 1 further comprising the steps of:
forming said light-penetratable film on a main surface of a second substrate; and
forming a cavity on said second substrate.

3. The method of claim 1, wherein said step of arranging is performed by anodic bonding.

4. The method of claim 1 further comprising the step of
forming a light-penetratable etching stopper film on said main surface of said light-penetratable film,
wherein said electrically conductive film is formed on said main surface of said light-penetratable film with said etching stopper film interposed therebetween.

5. The method of claim 1, wherein
a plurality of said concave portions are formed in the step of forming said concave portion,
a plurality of said pairs of electrodes are formed in the step of forming said pair of electrodes, and
the method further comprises the step of dividing said first substrate to separate the plurality of said concave portions from each other after said step of arranging.

6. The method of claim 1, wherein
said step of arranging comprises the step of applying an additive into said concave portion, and
said light-penetratable film is arranged on said first substrate in an atmosphere of an inert gas.

7. The method of claim 1, wherein said step of arranging comprises the steps of:
applying an additive and a liquid inert gas into said concave portion; and
raising temperature to room temperature after said light-penetratable film is arranged on said first substrate.

8. A discharge light source that emits light by discharge between a pair of electrodes arranged within a sealed space comprising:
a first substrate formed of silicon and having a concave portion formed thereon;
a light-penetratable film formed on a main surface of said first substrate to seal said concave potion; and
said pair of electrodes arranged within said sealed space formed by said concave portion and said light-penetratable portion.

9. The discharge light source of claim 8, wherein said pair of electrodes is formed of tungsten or molybdenum.

10. The discharge light source of claim 8, wherein said light-penetratable film is formed of at least one material selected from the group consisting of silicon nitride, silicon carbide, and diamond.
